(19) United States
(12) Patent Application Publication
(10) Pub. No.: US 2010/0017333 A1
(43) Pub. Date: Jan. 21, 2010

(54) METHODS AND SYSTEMS FOR CONDUCTING ELECTRONIC COMMERCE

(75) Inventor: Paul Turgeon, Chicago, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Payments & Processing Consultants, Inc., Chicago, IL (US)

(21) Appl. No.: 12/173,633

(22) Filed: Jul. 15, 2008

(51) Int. Cl. G06Q 20/00; G06Q 40/00; H04L 9/32; G06F 21/00

(52) U.S. Cl. 705/67; 705/35; 705/76; 705/75; 713/186

(57) ABSTRACT

Methods are disclosed of processing financial transactions. A connection is established over a public network between a customer client and a merchant server. A file is received over the connection from the merchant server at the customer client. An application is launched at the merchant server in response to receiving the file. Financial transaction data are received with the launched application. The received financial transaction data are transmitted with the launched application over the connection from the customer client to the merchant server to initiate processing of the financial transaction with the received financial transaction data.

### BACKGROUND OF THE INVENTION

This application relates generally to electronic commerce. More specifically, this application describes methods and systems for conducting electronic commerce that uses client-side applications to provide transaction information.

In recent years, the prevalence of electronic commerce has been steadily and persistently increasing. In its basic paradigm, electronic commerce takes place when a customer makes use of a public network such as the Internet to connect to a merchant server. This connection typically provides the customer with the ability to view product and/or service offerings of the merchant over a graphical interface and to make selections of the products or services to be sold. Once the desired products and/or services have been selected, the customer is asked to provide payment information that is verified before the products and/or services are provided by the merchant.

This basic paradigm generally works well, but the options for payment are limited by the types of payment information that can be collected by the merchant server. In addition, there are various security concerns that exist because information is collected by the merchant server in a fashion that makes it somewhat vulnerable to interception. There is accordingly a general desire in the art for mechanisms that can enhance the flexibility of information that can be collected and used by the merchant server in a secure fashion.

### BRIEF SUMMARY OF THE INVENTION

Embodiments of the invention provide methods of processing financial transactions. In a first set of embodiments, a connection is established over a public network between a customer client and a merchant server. A file is received over the connection from the merchant server at the customer client. An application is launched at the customer client in response to receiving the file. Financial transaction data are received with the launched application. The received financial transaction data are transmitted with the launched application over the connection from the customer client to the merchant server to initiate processing of the financial transaction with the received financial transaction data.

The connection may comprise an electronic connection. In some instances, the received financial transaction data are encrypted prior to transmitting the received financial transaction data to the merchant server.

The received financial transaction data may comprise a variety of different types of information. In one embodiment, the received financial transaction data comprise customer identification data identifying a customer party to the financial transaction. In another embodiment, the received financial transaction data comprise customer account data identifying a customer account to be used in support of the financial transaction. The customer account data might be received from a magnetic-stripe reader in communication with the customer client or might be received from a radio-frequency reader in communication with the customer client in different embodiments. In some cases, the received financial transaction data comprise a customer biometric received from a biometric reader in communication with the customer client.

In a second set of embodiments, a connection is also established over a public network between a customer client and a merchant server. A file is transmitted from the merchant server over the connection to the customer client. Financial transaction data collected at the customer client are received over the connection at the merchant server.

In these embodiments, the connection may also comprise an electronic connection. In some instances, the received financial transaction data are encrypted, and generating the authorization request comprises decrypting the encrypted received financial transaction data.

The received financial transaction data may also comprise customer identification data and/or customer account data, such as might be received from a magnetic-stripe reader or radio-frequency reader in communication with the customer client. The received financial transaction data may also comprise a customer biometric received from a biometric reader in communication with the customer client.

The methods of the present invention may be embodied in systems having a communications device, a processor, a storage device, and a memory coupled with the processor. The memory comprises a computer-readable medium having a computer-readable program embodied therein for directing operation of the respective system in accordance with the various embodiments described above.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 is a block-diagram representation of a typical structure that may be used in performing electronic commerce;

FIG. 2 is a flow diagram illustrating a typical flow in electronic commerce when financial payment information is provided directly to the merchant server;

FIG. 3 is a block-diagram representation of a structure that may be used in performing electronic commerce in accordance with embodiments of the invention;

FIG. 4 is a flow diagram illustrating a flow in electronic commerce in accordance with embodiments of the invention where financial payment information is collected at a customer client; and

FIG. 5 is a schematic illustration of a computer system on which methods of the invention may be embodied.

### DETAILED DESCRIPTION OF THE INVENTION

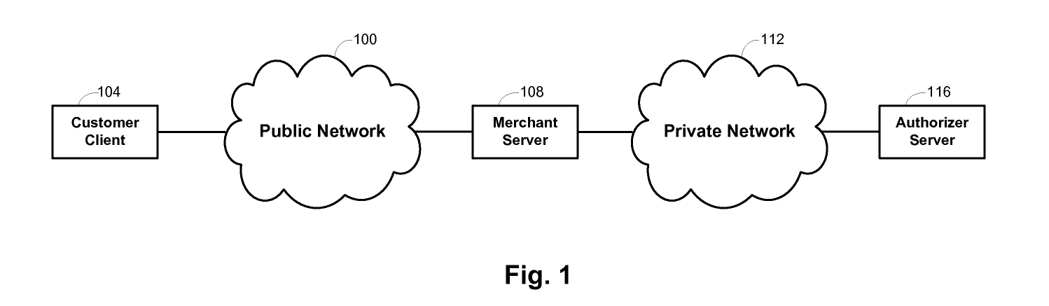

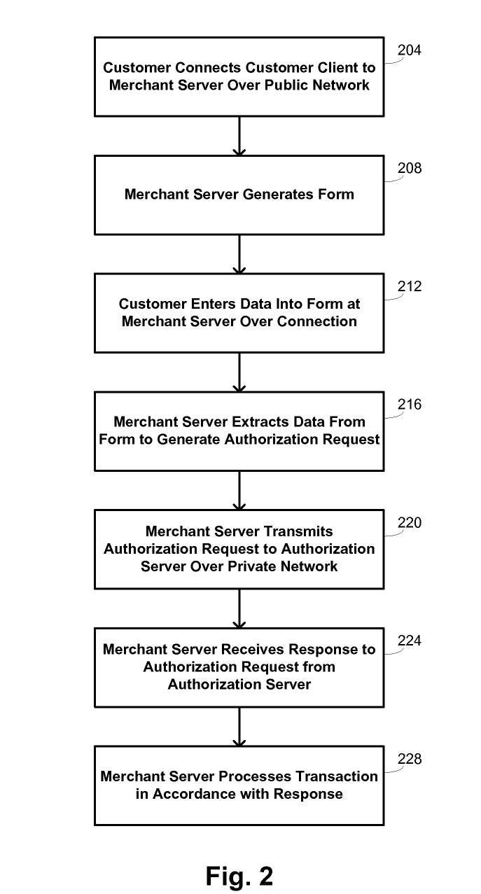

The basic paradigm for electronic commerce may be understood with reference to FIGS. 1 and 2, which respectively show a structure of an architecture used for electronic commerce and a flow diagram that illustrates how electronic commerce may be performed within such an architecture. A particular feature with embodiments of the invention is that a software application may be used in the collection of financial transaction and data that resides on a customer client. As such, collection of such data may be performed separately from the operations of a merchant server or an interconnection application such as a browser application that connects the customer client with the merchant server.

This may be illustrated by considering methods of conducting electronic commerce conventionally. The architecture of FIG. 1 includes three computational devices, namely a customer client 104, a merchant server 108, and an authorizer server 116. The customer client 104 is generally under the control of the customer making a purchase; the merchant server 108 is generally under the control of the merchant selling to the customer; and the authorizer server 116 is generally under the control of an entity that is responsible for an account that may be used to support the transaction. Thus, in some instances, the authorizer server 116 is under the control of a financial entity with whom the customer has a relationship to provide financial support for transactions entered into by or on behalf of the customer. Communications involved in performing an electronic transaction may include communications effected both over a public network 100 like the Internet or over a private network 112. Each of the computational devices may take a variety of different forms, particularly the customer client 104, which might comprise a personal computer, a laptop, a handheld computational device like a personal digital assistant or cellular telephone, and the like.

As indicated at block 204 of FIG. 2, a conventional electronic transaction that uses the architecture of FIG. 1 begins when a customer connects the customer client 104 to the merchant server 108 over the public network 100. After products and/or services have been identified and selected, the merchant server generates a form at block 208 to receive payment information. This payment information is provided by the customer over the connection at block 212. This information is provided by populating fields in the form that is maintained at the merchant server, such as by providing a name, address, credit- or debit-card number, a verification number, shipping instructions, and the like. Information is thus keyed by the customer into the merchant server 108.

The merchant server 108 extracts the data from the form to generate an authorization request that includes such information, as well as information regarding details of the transaction. Such information usually includes at least a total cost for the transaction, but may in some instances include other information about the transaction, such as information that defines the nature of the individual products and/or services. Such information might be provided in accordance with standardized classification systems, including, for example, the Universal Product Code (“UPC”) system, the European Article Number (“EAN”) system, the Global Trade Item Number (“GTIN”) system, the Serialized Shipping Container Code (“SSCC”) system, the Global Location Number (“GLN”) system, the Global Returnable Asset Identifier (“GRAI”) system, the Global Individual Asset Identifier (“GIAI”) system, and the Global Service Relation Number (“GSRN”) system, among others. Many of these systems are currently administered by the Uniform Code Council, Inc. (“UCC”) and EAN International.

The merchant server 108 then transmits the authorization request over the private network 112 at block 220 to the authorizer server 116 so that the authorizer server may determine whether to authorize the transaction in accordance with established criteria. For example, the decision to authorize the transaction in the case of a credit transaction may be as simple as verifying that the available balance on a credit account identified by the authorization request is greater than the total transaction amount. Similarly, the decision to authorize a debit transaction may be as simple as verifying that an account identified by the authorization request has an available balance greater than the total transaction amount. Other types of accounts that may be used to support transactions in different embodiments include stored-value accounts, bonus-point accounts, and so on. In other circumstances, the decision to authorize a transaction may depend on specific characteristics of the products and/or services to be purchased, such as where an account is limited to purchases only of specific products or is limited to purchases only from specific merchants.

The authorizer server 116 returns a response that is received by the merchant server 108 at block 224, allowing the transaction to be processed in accordance with the response at block 228. In particular, the transaction will usually either be approved or denied so that the merchant can decide whether to proceed with the transaction or not.

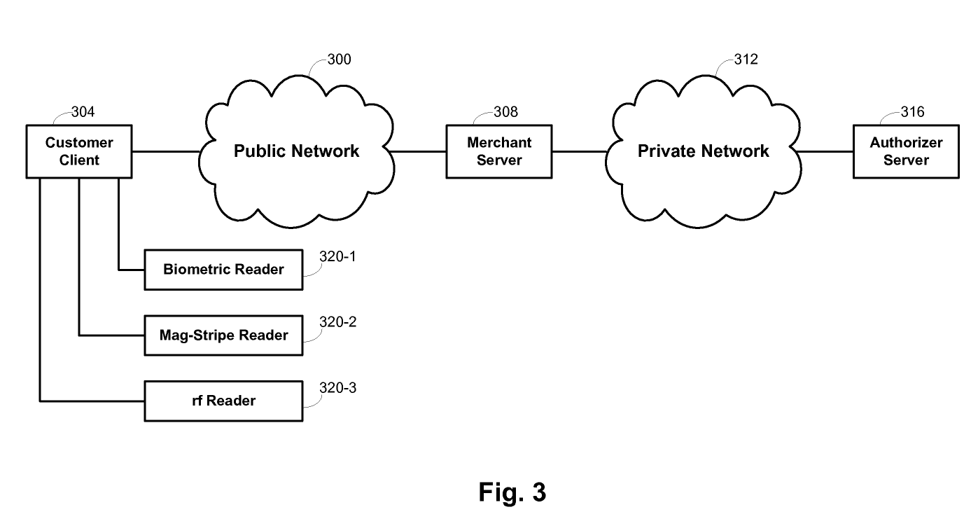

Embodiments of the invention make use of an architecture like that shown in FIG. 3. This architecture is similar to the architecture of FIG. 1, having a customer client 304, a merchant server 308, and an authorizer server 316 that communicate over public and private networks 300 and 312 as indicated in the drawing. In addition, though, the customer client 304 may be interfaced with a variety of additional devices 320 that find utility as described below, examples of which include a biometric reader 320-1, a magnetic-stripe reader 320-2, and/or a radio-frequency (“rf”) reader 320-3. The biometric reader 320-1 could comprise a fingerprint reader, an iris scanner, a hand-geometry reader, or any other type of biometric reader.

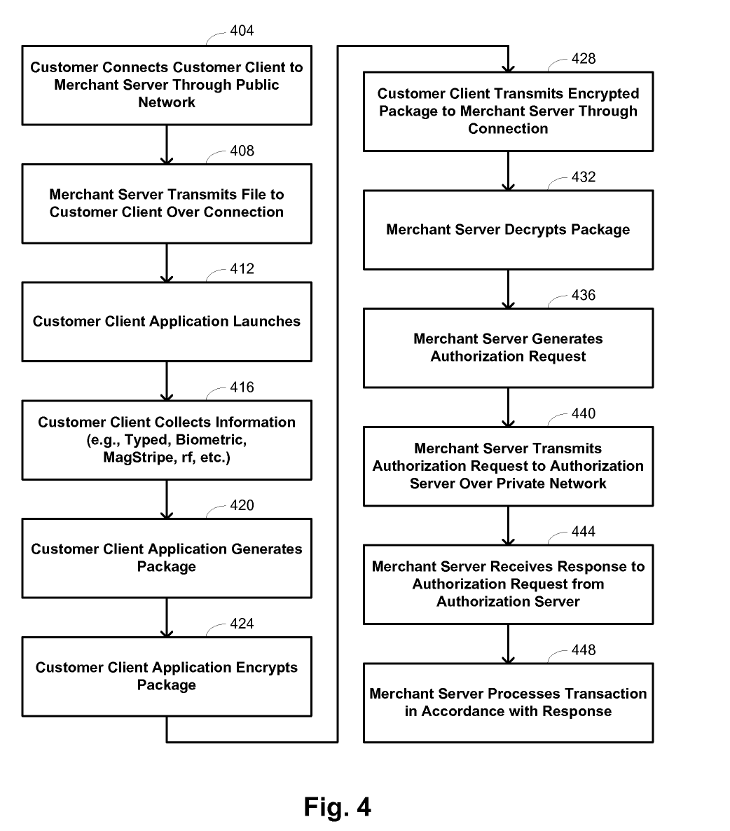

Methods for conducting electronic commerce using this architecture are summarized with the flow diagram of FIG. 4, which begins at block 404 when the customer connects the customer client 304 to the merchant server 308 over the public network 300. In specific embodiments, the public network 300 is the Internet. To initiate a transaction, the merchant server 308 transmits a file to the customer client 304 over the connection at block 408. The customer client 304 includes an application that is launched in response to transmission of the file at block 412, perhaps by detection of a particular file extension.

The launched application is one that allows the customer client 304 to collect relevant information. Such information may include financial transaction data as well as other types of data. As used herein, the term “financial transaction data” is intended to be construed broadly as including any data that is used in defining, conducting, or supporting a financial transaction. Examples of financial transaction data thus include information that identifies a financial account used in support of the transaction, personal or biometric information that identifies a party to the transaction, a cost of the transaction, and the like. In some instances, the financial transaction data may also include information about the nature of the transaction, such as through the use of “condition codes,” the nature of which are described more fully below.

The collection of relevant information is specifically performed at the client 304 rather than at the server 308 and provides additional flexibility to include additional information in transaction requests in a straightforward fashion. Specifically, the collection of information is not limited to textual information provided by the customer, although such information may be collected by the launched application. In addition to such textual information, any of the devices provided in communication with the customer client 304 may provide additional information that forms part of the transaction information.

For instance, the biometric reader 320-1 may collect a biometric signature from the customer that is transmitted to the application and incorporated as part of the transaction information. In some embodiments, the application includes software that implements a spoof-detection methodology in which it limits the biometric information to information collected from the biometric reader 320-1 at substantially that time; it may also apply any of a variety of spoof-detection techniques on the collected data such as is known in the art to ensure that the biometric information is genuine.

In other embodiments, the biometric signature of the customer may be verified prior to collecting or releasing relevant information with the application launched at the customer client. In still other embodiments, the biometric signature or other forms of individual authentication of the customer may be verified prior to transmittal of the transaction information. For instance, the biometric collected by the biometric reader 320-1 may be compared with a biometric stored on the customer client using software that is comprised by the launched application, or might be compared or interpreted by a third party. Such a third-party comparison can be carried out by the launched application establishing a connection with the third party and transmitting the collected biometric signature or other information to the third party over the connection. Such third-party connections may also be used in various embodiments in other applications also, including both applications that involve authentication of the customer and other applications.

Similarly, the magnetic-stripe reader 320-2 may be used to collect track data from the magnetic stripe of a magnetic-stripe card such as a credit card, a debit card, a stored-value card, or the like. The information extracted from such a magnetic stripe typically identifies the holder of an account to be used in support of the transaction as well as the account itself in the from of an account number. Verification information may also be extracted from the magnetic stripe that can be used in a self-authenticating fashion to confirm the actual presence of the card.

The same kind of information may be collected using the rf reader 320-3 for those applications in which the customer is able to present a transponder device. As is known in the art, the transponder device, which may be embodied as part of a card, a key fob, or any of numerous other structures, responds to transmission of a radio-frequency signal from the rf reader 320-3 to provide information similar to that available on a magnetic stripe. In this way, the customer client 304 may extract information from the transponder device that is included as part of the transaction information.

There are a variety of different ways in which this information may be included as part of the transaction information, including through the use of condition codes as mentioned above. Such codes are used to define circumstances that define the nature of a transaction, For example, a condition code might conventionally identify a transaction as involving a credit account, involving a debit account, or involving some other kind of account in different instances. In some embodiments, the condition codes may also define whether the customer has previously been authenticated, such as by a third party or through the use of biometric information. It may be used to identify the type of information that is being included, such as including a code that indicates that biometric information is included, that magnetic-stripe information is included, that rfid information is included, the author of the launched application, the identifier of the launched application, the type of consumer client used, and so on. In instances where the customer client comprises a personal computer, the condition codes might comprise a “signature” of the personal computer that identifies it uniquely. In instances where the consumer client comprises a portable computer, the condition codes might comprise an approximate location indicator as determined by the IP address. In cases where the customer client comprises a cellular telephone, the condition codes might comprise a location identifier of the cellular telephone as determined by a global positioning system (“GPS”). Still other kinds of condition codes may be used in other embodiments to identify other conditions about the origin of the transaction.

It is worth noting that the various devices coupled with the customer client 304 may have complementary or noncomplementary functionality. For instance, in a case where a magnetic-stripe reader 320-2 and an rf reader 320-3 are provided, it will usually be the case that a single transaction will use either the information collected from a magnetic stripe or from a transponder device but not from both. In some applications, however, it is possible that the source of transaction funds might be split so that information from both is in fact used in a single transaction. In a case where a magnetic-stripe reader 320-2 and a biometric reader 320-1 are provided, it will more usually be the case that information collected from both are used in a single transaction. That is, an identity of a person defined by the magnetic-stripe information may be verified with the biometric information. Such verification may be performed using the launched application at the customer client or may be deferred to a later point in the methodology.

Once the various component pieces of information are received by the application, the customer-client application generates a package at block 420 that includes these, and encrypts the package at block 424 so that it may be transmitted back to the merchant server 308 over the public network at block 428. The encryption may be performed using any of several encryption techniques known to those of skill in the art, such as by using a form of key encryption like public-key encryption.

The use of such an encryption technique allows the package to be decrypted by the merchant server 308 after it has been receive, as indicated at block 432. Such decryption recovers the component pieces of information that were collected by the customer-client application and may include at least as much information as received by the merchant server 108 in the method of FIG. 2. In most embodiments, more information is available to the merchant server 308 and it has been collected in a manner that allows more flexibility for the type and character of the information. The merchant server 308 may accordingly perform its own validation and verification processes on the data, confirming consistency among the different kinds of data in a way that lessens the possibility of fraud.

At block 436, the merchant server 308 accordingly generates an authorization request that may be processed in the same way as the authorization request discussed in connection with FIG. 2 is processed. Specifically, the merchant server 308 transmits the authorization request to the authorizer server 316 over the private network 312 at block 440. The authorizer server 316 applies its standard methodology to the authorization request to determine what form of response to return, usually an approval of the transaction or a denial of the transaction, although other responses are possible, including a partial approval/partial denial of the transaction. Approval of a transaction usually results when an available balance for an account exceeds the total transaction amount and denial of a transaction usually results when the available balance is less than the transaction amount; in the case of a credit account, the available balance is the outstanding credit available, and in the case of debit or stored-value account, the available balance is the value credited to the account.

The response generated by the authorizer server 316 is returned over the private network to the merchant server 308 so that it can be received at block 444 and an appropriate action taken in accordance with the response at block 448. The action that is taken is usually one of proceeding with the transaction when an approval is received or not proceeding with the transaction if a denial is received.

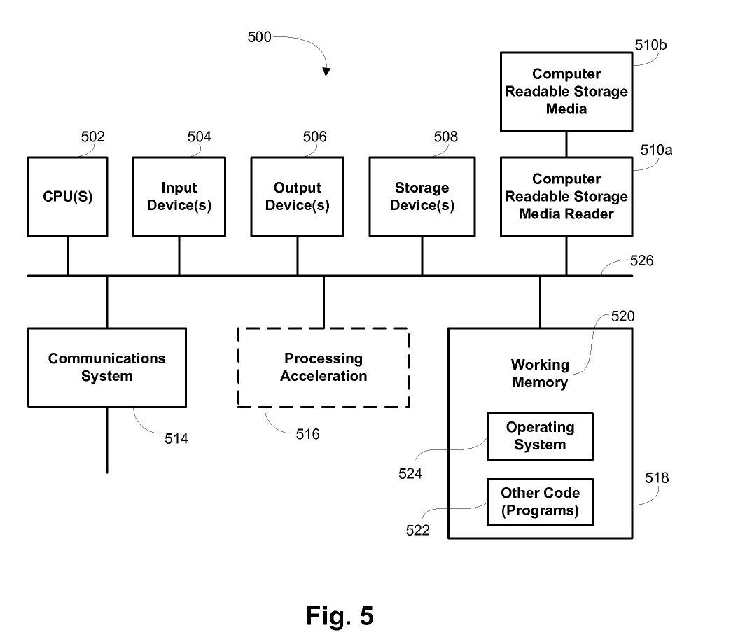

Each of the computational devices shown in FIGS. 1 and 3 may be embodied with a structure like that shown in FIG. 5. Specifically, such a structure 500 may be used for the customer client, the merchant server, and/or the authorizer server. FIG. 5 broadly illustrates how individual system elements may be implemented in a separated or more integrated manner. The computational devices 500 are each shown comprised of hardware elements that are electrically coupled via bus 526, including a processor 502, an input device 504, an output device 506, a storage device 508, a computer-readable storage media reader 510a, a communications system 514, a processing acceleration unit 516 such as a DSP or special-purpose processor, and a memory 518. The computer-readable storage media reader 510a is further connected to a computer-readable storage medium 510b, the combination comprehensively representing remote, local, fixed, and/or removable storage devices plus storage media for temporarily and/or more permanently containing computer-readable information. The communications system 514 may comprise a wired, wireless, modem, and/or other type of interfacing connection and permits data to be exchanged with the public and/or private networks, as described above.

The computational devices 500 also each comprise software elements, shown as being currently located within working memory 520, including an operating system 524 and other code 522, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. A method of processing a financial transaction, the method comprising:
establishing a connection over a public network between a customer client and a merchant server;
receiving a file over the connection from the merchant server at the customer client;
launching an application at the customer client in response to receiving the file;
receiving financial transaction data with the launched application; and
transmitting the received financial transaction data with the launched application over the connection from the customer client to the merchant server to initiate processing of the financial transaction with the received financial transaction data.

2. The method recited in claim 1 wherein the connection comprises an electronic connection.

3. The method recited in claim 1 further comprising encrypting the received financial transaction data prior to transmitting the received financial transaction data to the merchant server.

4. The method recited in claim 1 wherein the received financial transaction data comprise customer identification data identifying a customer party to the financial transaction.

5. The method recited in claim 1 wherein the received financial transaction data comprise customer account data identifying a customer account to be used in support of the financial transaction.

6. The method recited in claim 5 wherein the customer account data is received from a magnetic-stripe reader in communication with the customer client.

7. The method recited in claim 5 wherein the customer account data is received from a radio-frequency reader in communication with the customer client.

8. The method recited in claim 1 wherein the received financial transaction data comprise a customer biometric received from a biometric reader in communication with the customer client.

9. A method of processing a financial transaction, the method comprising:
establishing a connection over a public network between a customer client and a merchant server;
transmitting a file from the merchant server over the connection to the customer client;
receiving over the connection at the merchant server financial transaction data collected at the customer client;
generating an authorization request from the received financial transaction data; and
transmitting the authorization request from the merchant server over a private network to an authorizer server.

10. The method recited in claim 9 wherein the connection comprises an electronic connection.

11. The method recited in claim 9 wherein:
the received financial transaction data is encrypted; and
generating the authorization request comprises decrypting the encrypted received financial transaction data.

12. The method recited in claim 9 wherein the received financial transaction data comprise customer identification data identifying a customer party to the transaction.

13. The method recited in claim 9 wherein the received financial transaction data comprise customer account data identifying a customer account to be used in support of the financial transaction.

14. The method recited in claim 13 wherein the customer account data is received from a magnetic-stripe reader in communication with the customer client.

15. The method recited in claim 13 wherein the customer account data is received from a radio-frequency reader in communication with the customer client.

16. The method recited in claim 9 wherein the received financial transaction data comprise a customer biometric received from a biometric reader in communication with the customer client.

17. A customer client comprising:
a communications device;
a processor;
a storage device; and
a memory coupled with the processor, the memory comprising a computer-readable storage medium having a computer-readable program embodied therein for directing operation of the processing system to process a financial transaction, the computer-readable program including:
instructions for establishing a connection over a public network between the customer client and a merchant server with the communications system;
instructions for receiving a file over the connection from the merchant server at the customer client;
instructions for launching an application with the processor at the merchant server in response to receiving the file;
instructions for receiving financial transaction data with the launched application; and
instructions for transmitting the received financial transaction data with the launched application over the connection from the customer client to the merchant server to initiate processing of the financial transaction with the received financial transaction data.

18. The customer client recited in claim 17 wherein the connection comprises an electronic connection.

19. The customer client recited in claim 17 wherein the computer-readable program further includes instructions for encrypting the received financial transaction data prior to transmitting the received financial transaction data to the merchant server.

20. The customer client recited in claim 17 wherein the received financial transaction data comprise customer identification data identifying a customer party to the financial transaction.

21. The customer client recited in claim 17 wherein the received financial transaction data comprise customer account data identifying a customer account to be used in support of the financial transaction.

22. The customer client recited in claim 21 wherein the customer account data is received from a magnetic-stripe reader in communication with the customer client.

23. The customer client recited in claim 21 wherein the customer account data is received from a radio-frequency reader in communication with the customer client.

24. The customer client recited in claim 17 wherein the received financial transaction data comprise a customer biometric received from a biometric reader in communication with the customer client.

25. A merchant server comprising:
a communications device;
a processor;
a storage device; and
a memory coupled with the processor, the memory comprising a computer-readable storage medium having a computer-readable program embodied therein for directing operation of the processing system to process a financial transaction, the computer-readable program including:
instructions for establishing a connection over a public network with the communications device between a customer client and the merchant server;
instructions for transmitting a file from the merchant server over the connection to the customer client;
instructions for receiving over the connection at the merchant server financial transaction data collected at the customer client;
instructions for generating an authorization request from the received financial transaction data; and
instructions for transmitting the authorization request from the merchant server over a private network with the communications device to an authorizer server.

26. The merchant server recited in claim 25 wherein the connection comprises an electronic connection.

27. The merchant server recited in claim 25 wherein:
the received financial transaction data is encrypted; and
the instructions for generating the authorization request comprise instructions for decrypting the encrypted received financial transaction data.

28. The merchant server recited in claim 25 wherein the received financial transaction data comprise customer identification data identifying a customer party to the transaction.

29. The merchant server recited in claim 25 wherein the received financial transaction data comprise customer account data identifying a customer account to be used in support of the financial transaction.

30. The merchant server recited in claim 29 wherein the customer account data is received from a magnetic-stripe reader in communication with the customer client.

31. The merchant server recited in claim 29 wherein the customer account data is received from a radio-frequency reader in communication with the customer client.

32. The merchant server recited in claim 25 wherein the received financial transaction data comprise a customer biometric received from a biometric reader in communication with the customer client.
